(19) United States
(12) Patent Application Publication
(10) Pub. No.: US 2010/0272396 A1
(43) Pub. Date: Oct. 28, 2010

(54) LC-TYPE OPTICAL CONNECTOR

(76) Inventors: Yasunari Komaki, Kyoto-shi (JP); Masaya Nakagawa, Kyoto-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/765,127

(22) Filed: Apr. 22, 2010

(30) Foreign Application Priority Data
Apr. 27, 2009 (JP) 2009-107968

(51) Int. Cl. G02B 6/38

(52) U.S. Cl. 385/60

(57) ABSTRACT

In an LC-type optical connector, a capillary is press-fitted into a fixation hole formed in a housing, and hence it is possible to omit a spring or a flange portion which is used in a conventional optical connector to fix a ferrule. Therefore, reduction in the numbers of components and reduction in cost can be achieved. Further, through omitting the spring or the flange portion, it is unnecessary to provide a space for receiving those members in an inside of the housing, and thus a shape of the housing is simplified. Consequently, manufacturing cost can be reduced.

### TECHNICAL FIELD

The present invention relates to an optical connector for connecting an optical fiber to another optical fiber or an optical element, and more particularly, to an LC-type optical connector.

### BACKGROUND ART

For example, in JP 2001-56420 A, there is described an LC-type optical connector including a ferrule (27) having a flange (26), a housing (constituted by a front portion (12) and a rear portion (13)) for holding the ferrule, and a latching arm (18) extending from the housing. The LC-type optical connector is attached to an optical adapter, and can be detached from the optical adapter while the latching arm (18) is elastically deformed. A through-hole is formed in the housing, and the ferrule is held in an inner periphery of the through-hole. Specifically, the through-hole is formed in each of the front portion (12) and the rear portion (13) of the housing. A forward end side of the ferrule is inserted into the through-hole of the front portion, and a proximal end side of the ferrule (which hereinafter refers to a side opposite to the forward end side thereof) is inserted into the through-hole of the rear portion. In this state, the front portion and the rear portion are fixed to each other, and thus the ferrule is mounted in the inner periphery of the through-hole of the housing.

### Citation List

Patent Literature: JP 2001-56420 A

### SUMMARY OF INVENTION

### Technical Problem

As described above, owing to a configuration in which the ferrule is completely received in the through-hole of the housing constituted by the front portion (12) and the rear portion (13), it is possible to reliably protect the ferrule from external impact. However, an optical connector used behind the wall (BTW), i.e., in an inside of a module box or the like, is rarely subjected to external contact, and hence the external impact is less likely to be applied thereto in comparison with an optical connector used on the wall (OTW). Thus, in the optical connector used under less external impact, the configuration having the above-mentioned housing constituted by a plurality of components becomes sometimes excessive.

Further, when an attempt is made to hold the ferrule having the flange in an inside of the housing as described above, an inner shape of the housing becomes complicated, and hence manufacturing cost of the housing is increased.

An object of the present invention is therefore to simplify a structure of the LC-type optical connector and to achieve reduction in cost.

### Solution to Problem

In order to achieve the above-mentioned object, the present invention provides an LC-type optical connector including: a capillary including a micropore through which an optical fiber is inserted; a housing for holding the capillary in a state in which the capillary is projected to one side in an axial direction thereof; and a latch provided integrally with the housing, for preventing the LC-type optical connector from slipping off from an optical adapter through being engaged with the optical adapter in the axial direction, the LC-type optical connector being detached from the optical adapter in a state in which the latch is elastically deformed to be disengaged from the optical adapter, in which the capillary is press-fitted and fixed to a fixation hole formed in the housing.

Here, the “axial direction” refers to a central axis direction of the capillary fixed to the housing.

As described above, the capillary is press-fitted into the fixation hole formed in the housing, and hence it is possible to omit a spring, a cap (rear portion (13)), or the flange of the ferrule which is used in a conventional optical connector to position the ferrule in the housing. Therefore, reduction in the numbers of components and reduction in cost can be achieved. Further, through omitting the spring or the flange, it is unnecessary to provide a space for receiving those members in an inside of the housing, and thus an inner shape of the housing is simplified. Consequently, formation of the housing is facilitated, and manufacturing cost is reduced.

When the capillary is press-fitted and fixed to the fixation hole of the housing from the one side in the axial direction thereof (the side on which the capillary is projected from the housing), it is possible to reduce an axial distance during press-fitting, to simplify a press-fitting operation, and to suppress deformation of the housing caused by the press-fitting.

### ADVANTAGEOUS EFFECTS OF INVENTION

As described above, according to the present invention, it is possible to simplify a structure of the optical connector and to achieve reduction in cost.

### BRIEF DESCRIPTION OF DRAWINGS

FIG. 1A A perspective view of an optical connector.

FIG. 1B A perspective view of the optical connector.

FIG. 2A A side view of the optical connector.

FIG. 2B A plan view of the optical connector.

FIG. 2C A front view of a forward end side of the optical connector.

FIG. 2D A front view of a proximal end side of the optical connector.

FIG. 3A A cross-sectional view taken along the line A-A of FIG. 2B.

FIG. 3B A cross-sectional view taken along the line B-B of FIG. 2A.

FIG. 3C A cross-sectional view taken along the line C-C of FIG. 2A.

FIG. 3D A cross-sectional view taken along the line D-D of FIG. 2A.

### DESCRIPTION OF EMBODIMENTS

In the following, an embodiment of the present invention is described with reference to the drawings.

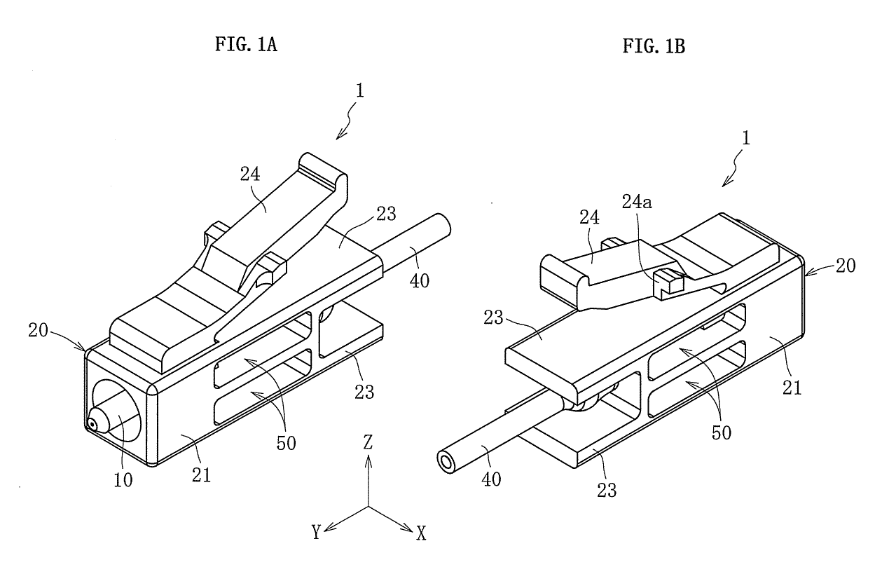

As illustrated in FIGS. 1A and 1B, an optical connector 1 according to the embodiment of the present invention includes a capillary 10 and a housing 20 for holding the capillary 10. The optical connector 1 is fixed to an optical adapter (not shown), and is a so-called LC-type optical connector which is prevented from slipping off from the optical adapter through engaging a latch 24 provided to the housing 20 with a locking portion of the optical adapter. The optical connector 1 is preferably used on a place where the optical connector is rarely subjected to external contact, and is used as, for example, an optical connector provided in an inside of a module box. Note that, in the following, for convenience of the description, a central axis direction (Y direction in FIGS. 1A and 1B) of the capillary 10 mounted to the housing 20 is referred to as an “axial direction”, a side on which the optical connector is mounted to the optical adapter is referred to as a forward end side, and a side opposite thereto is referred to as a proximal end side. Further, a Z direction illustrated in FIGS. 1A and 1B is referred to as an up-down direction, a side on which the latch 24 of the housing 20 is provided is referred to as an upper side, and a side opposite thereto is referred to as a lower side. Moreover, a direction (X direction in FIGS. 1A and 1B) orthogonal to both of the axial direction and the up-down direction is referred to as a width direction.

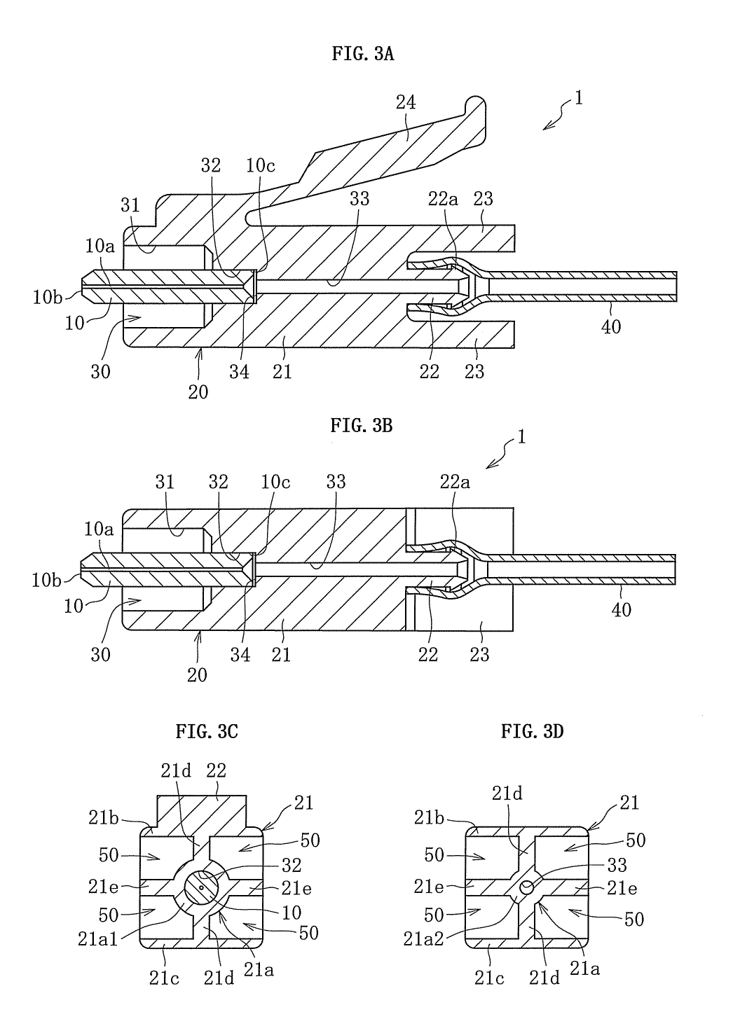

The capillary 10 is integrally made of a material such as ceramics (zirconia, for example) or glass, and includes a micropore 10a which extends in the axial direction and through which an optical fiber (optical fiber wire or optical fiber wire with coating (not shown)) is inserted (see FIG. 3A). The capillary 10 has a cylindrical outer peripheral surface, and includes a tapered and chamfered forward end portion. In a state in which the forward end portion thereof is projected from the housing 20, the capillary 10 is press-fitted and fixed to the housing 20.

The housing 20 includes a main body 21 of a substantially rectangular parallelepiped, a cylinder portion 22 and a cover portion 23 extending from the main body 21 to the proximal end side, and the latch 24 provided on one side surface (upper surface) of the main body 21. The housing 20 is integrally die-molded by injection molding of, for example, a resin material.

An axial through-hole 30 is formed in the main body 21 (see FIG. 3A.) The through-hole 30 includes a larger-diameter hole 31 opened in a forward end surface of the main body 21, a fixation hole 32 provided on the proximal end side of the larger-diameter hole 31, and a communication hole 33 provided on the proximal end side of the fixation hole 32. A proximal end portion of the capillary 10 is press-fitted into the fixation hole 32, and the capillary 10 projects from the forward end portion of the housing 20.

An inner diameter of the fixation hole 32 is set to be slightly smaller than an outer diameter of the capillary 10. Through adjusting a diameter difference (press-fitting allowance) between the fixation hole 32 and the capillary 10, the proximal end portion of the capillary 10 can be reliably fixed to the fixation hole 32 with good accuracy. An inner diameter of the larger-diameter hole 31 is set to be larger than the inner diameter of the fixation hole 32. When the optical connector 1 is mounted to the optical adapter, the larger-diameter hole 31 is fitted to a boss portion (not shown) of the optical adapter. The communication hole 33 has a diameter smaller than a diameter of the fixation hole 32, and has a diameter uniform in the axial direction. An axial gap is formed between a proximal end portion 10c of the capillary 10 and a shoulder surface 34 formed between the communication hole 33 and the fixation hole 32.

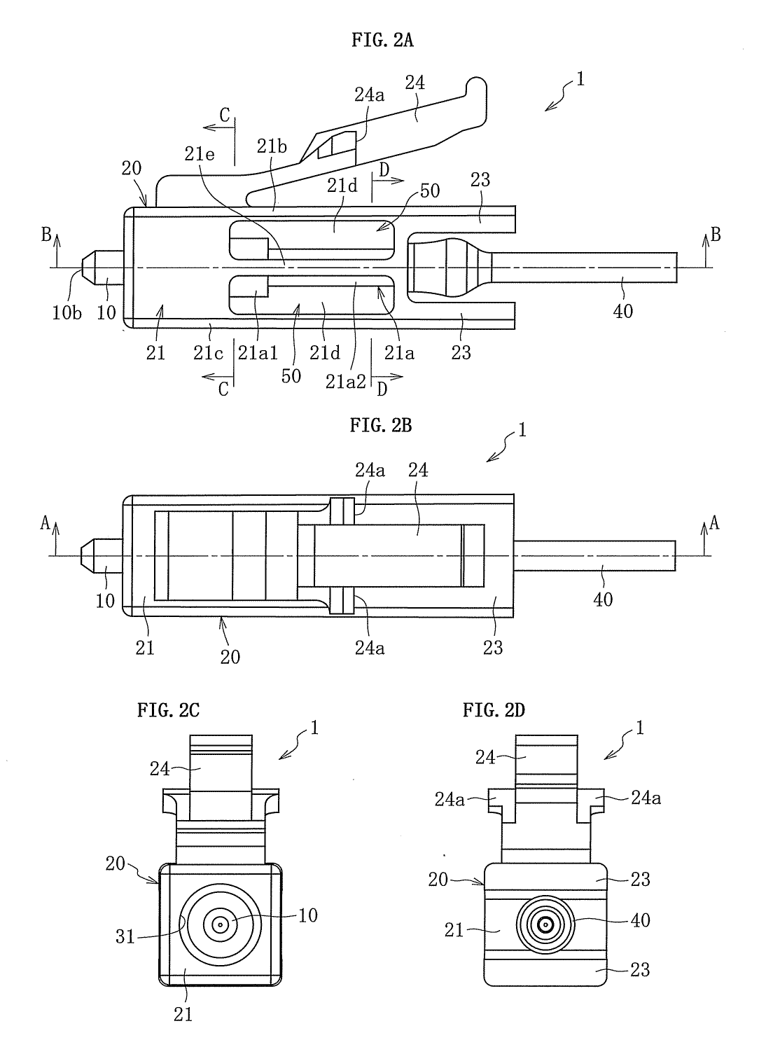

As illustrated in FIGS. 1A and 1B, the main body 21 has a configuration in which eliminated portions 50 are formed at two upper and lower positions in each of substantially rectangular side surfaces located on both sides in the width direction thereof. In this way, through forming the eliminated portions 50 in the housing 20, it is possible to reduce a thickness of the housing 20, and to suppress molding shrinkage. Specifically, as illustrated in FIGS. 2A, 3C, and 3D, the main body 21 includes a cylindrical portion 21a having the through-hole 30 formed in its inner periphery, an upper wall portion 21b provided above the cylindrical portion 21a, a lower wall portion 21c provided below the cylindrical portion 21a, support portions 21d extending in the up-down direction to couple the cylindrical portion 21a with the upper wall portion 21b and the lower wall portion 21c, and support portions 21e extending from the cylindrical portion 21a to the both sides in the width direction thereof. Each of the eliminated portions 50 is formed by a space surrounded by the cylindrical portion 21a, one of the support portions 21d extending in the up-down direction, one of the support portions 21e extending in the width direction, and the upper wall portion 21b or the lower wall portion 21c. The cylindrical portion 21a includes a larger-diameter cylindrical portion 21a1 having the fixation hole 32 formed therein, and a smaller-diameter cylindrical portion 21a2 having the communication hole 33 formed therein.

As illustrated in FIGS. 3A and 3B, the cylinder portion 22 has the communication hole 33 formed in its inner periphery to extend from the main body 21, and includes a claw portion 22a formed on its outer peripheral surface. Proximal end side surfaces of the claw portion 22a are tapered so that an outer diameter of the claw portion 22a is gradually decreased in diameter to the proximal end side thereof. The optical fiber (not shown) is inserted through the inner periphery of the cylinder portion 22, and a protective tube 40 is mounted so as to cover both of the outer peripheral surface of the cylinder portion 22 and the outer peripheral surface of the optical fiber. The protective tube 40 is made of a material (fluororesin or rubber, for example) being elastic enough to be able to be mounted on the outer periphery of the cylinder portion 22. Further, the protective tube 40 may be made of a material having a heat shrinkage property and be formed into a so-called heat-shrinkable tube. By being caused to shrink by heating, the protective tube 40 may be brought into close contact with the cylinder portion 22 and the optical fiber. The claw portion 22a of the cylinder portion 22 bites into an inner peripheral surface of the protective tube 40, and thus the protective tube 40 is elastically deformed to a radially outer side thereof. As a result, the protective tube 40 and the claw portion 22a are engaged with each other in the axial direction, and hence the protective tube 40 is regulated from slipping off. The protective tube 40 prevents a situation in which the optical fiber is bent at an entrance portion (proximal end portion) of the cylinder portion 22.

The cover portion 23 projects from the main body 21 to the proximal end side in the axial direction, and extends beyond the cylinder portion 22 to the proximal end side thereof. In the illustrated example, a pair of long plate-like members provided above and below the cylinder portion 22 constitute the cover portion 23, and the cover portion 23 covers the cylinder portion 22 from both sides in a diameter direction thereof. Owing to provision of the cover portion 23, it is possible to protect a connecting portion between the cylinder portion 22 and the optical fiber, and to more reliably prevent the situation in which the optical fiber is bent at the entrance portion (proximal end portion) of the cylinder portion 22. In this way, the cover portion 23 for protecting the optical fiber is integrally provided to the housing 20, and thus it is unnecessary to separately provide a member such as a boot. Consequently, it is possible to achieve reduction in cost due to reduction in the numbers of components.

The latch 24 extends obliquely upward from a forward-end side portion of the upper surface of the main body 21 to the proximal end side, and includes on its middle portion a locking surface 24a facing the forward end side (see FIGS. 1A, 1B, and the like). In a state in which the optical connector 1 is mounted to the optical adapter, the locking surface 24a is engaged with the locking portion of the optical adapter in the axial direction, and thus the optical connector 1 is regulated from slipping off from the optical adapter. The latch 24 is pushed downward while being elastically deformed, and engagement between the locking surface 24a and the locking portion of the optical adapter is released. Consequently, the optical connector 1 can be detached from the optical adapter.

The optical connector 1 having the above-mentioned configuration is assembled as follows. First, the proximal end portion of the capillary 10 is press-fitted into the fixation hole 32 of the housing 20 from the forward end side in the axial direction thereof. In this case, an insertion depth of the capillary 10 is adjusted so that an axial distance between a forward end portion 10b of the capillary 10 and the locking surface 24a of the latch 24 is set within a predetermined dimensional range. For example, the capillary 10 is press-fitted into the fixation hole 32 while being held by a jig (not shown), and the jig is brought into contact with the locking surface 24a. Thus, it is possible to control the insertion depth of the capillary 10.

Then, the protective tube 40 is fixed to the cylinder portion 22 of the housing 20, and an adhesive is applied to the through-hole 30 of the housing 20 from an opening portion on the proximal end side of the protective tube 40. The optical fiber (not shown) is inserted from the proximal end side of the protective tube 40 through the inner periphery of the communication hole 33 applied with the adhesive. In addition, the optical fiber is inserted through the micropore 10a of the capillary 10, and the optical fiber is caused to stick out of the forward end portion 10b of the capillary 10. In this state, through curing the adhesive, the housing 20 and the optical fiber are integrated together. Then, a portion of the optical fiber sticking out of the forward end portion 10b is eliminated, and the forward end portion 10b of the capillary 10 is polished and finished with high accuracy. Thus, assembly of the optical connector 1 is completed.

As described above, the capillary 10 is press-fitted and fixed to the housing 20, and hence it is possible to omit a spring or a flange which is provided to a conventional optical connector. Thus, an inner shape (that is, shape of the through-hole 30) of the housing 20 is simplified, and hence it is possible to facilitate design of a die used for molding the housing 20, and to reduce manufacturing cost. Further, the capillary 10 is press-fitted into the fixation hole 32 from the forward end side thereof, and hence the axial distance during press-fitting can be reduced in comparison with, for example, a case where the capillary 10 is press-fitted from the proximal end side thereof. Therefore, it is possible to simplify a press-fitting operation, to reduce load applied to the housing by the press-fitting, and to suppress deformation of the housing. Further, the capillary 10 is press-fitted from the forward end side thereof, and hence it is only necessary to form the communication hole 33 provided on the proximal end side of the fixation hole 32 into a shape allowing the optical fiber to be inserted therethrough. Thus, the communication hole 33 can be formed into a cylindrical shape with a small diameter as in the illustrated example. Such optical connector 1 can be preferably used on a place where the optical connector is rarely subjected to external impact (in an inside of a module box, for example). On such place, it is less necessary to protect the optical fiber with a resin jacket or the like, and the optical connector can be used in a state in which the optical fiber is exposed. As a matter of course, there may be used a so-called optical cable in which the optical fiber is protected with the resin jacket or the like and a reinforcing fiber is interposed between the resin jacket and the optical fiber.

Further, the capillary 10 is fixed to the housing 20 without use of a spring or a flange portion, and hence it is possible to prevent positional accuracy between the capillary 10 and the housing 20 from being deteriorated due to an assembly error, etc. In this case, when the housing 20 is integrally injection-molded as described above, the main body 21, the cylinder portion 22, the cover portion 23, the latch 24, and the through-hole 30 are integrally molded with the same die, and hence dimensional accuracy of respective components, in particular, dimensional accuracy of the locking surface 24a and the fixation hole 32 can be increased. Through press-fitting the capillary 10 into the fixation hole 32, it is possible to increase positioning accuracy between the forward end portion 10b of the capillary 10 and the locking surface 24a.

### REFERENCE SIGNS LIST

1 optical connector
10 capillary
20 housing
21 main body
22 cylinder portion
23 cover portion
24 latch
24a locking surface
30 through-hole
31 larger-diameter hole
32 fixation hole
33 communication hole
40 protective tube
50 eliminated portion

1. An LC-type optical connector, comprising:
a capillary comprising a micropore through which an optical fiber is inserted;
a housing for holding the capillary in a state in which the capillary is projected to one side in an axial direction thereof; and
a latch provided integrally with the housing, for preventing the LC-type optical connector from slipping off from an optical adapter through being engaged with the optical adapter in the axial direction,
the LC-type optical connector being detached from the optical adapter in a state in which the latch is elastically deformed to be disengaged from the optical adapter,
wherein the capillary is press-fitted and fixed to a fixation hole formed in the housing.

2. An LC-type optical connector according to claim 1, wherein the capillary is press-fitted and fixed to the fixation hole formed in the housing from the one side in an axial direction.
